(19) United States
(12) Patent Application Publication
(10) Pub. No.: US 2026/0067108 A1
(43) Pub. Date: Mar. 5, 2026

(54) POWER MANAGEMENT METHOD AND MULTI-CHIP SYSTEM

(71) Applicant: REALTEK SEMICONDUCTOR CORP., Hsinchu (TW)

(72) Inventors: Qi-Yang Tang, Suzhou (CN); Jia-Ming Hu, Suzhou (CN); Peng-Chao Teng, Suzhou (CN); Bai-Wen Ding, Suzhou (CN)

(73) Assignee: REALTEK SEMICONDUCTOR CORP., Hsinchu (TW)

(21) Appl. No.: 19/314,527

(22) Filed: Aug. 29, 2025

(30) Foreign Application Priority Data
Sep. 2, 2024 (CN) 202411223456.4

(51) Int. Cl. H04L 12/10

(52) U.S. Cl. CPC H04L 12/10

(57) ABSTRACT

A power management method includes: executing an initialization procedure to obtain a remaining available power value; sequentially executing a power supply procedure for each of the communication ports; calculating the power consumed by each of the communication ports that are powered on; summing the power consumed by all the communication ports that are powered on to obtain a local used power value; subtracting the used power value of the storage unit of the chip having the previous priority and the local used power value from the total power value to obtain a second remaining available power value; and in response to that the second remaining available power value is greater than or equal to 0, adding the local used power value to the used power value of the storage unit of the chip having the previous priority to obtain the used power value.

### CROSS-REFERENCE TO RELATED APPLICATION

This non-provisional application claims priority under 35 U.S.C. § 119(a) to Patent Application No. 202411223456.4 filed in China on Sep. 2, 2024, the entire contents of which are hereby incorporated by reference.

### BACKGROUND

### Technical Field

The instant disclosure relates to a power management technology, specifically a power management method and a multi-chip system.

### Related Art

Power over Ethernet (PoE) technology can transmit data signals and provide DC power to IP-based terminals. The PoE technology boasts numerous advantages, including high compatibility with wiring methods, low power supply costs, flexible deployment, high support rate for Powered Devices (PD), and centralized and flexible power management. For PoE systems with multiple communication ports, safety, efficiency, accuracy, and configurability are several important objectives of power management strategies. A deep understanding of the connections and differences between these objectives, and balancing all objectives to the greatest extent possible, is the starting point for designing power management strategies.

Safety refers to controlling over the power supply capability, quantity, and rhythm of each of the communication ports in the system, as well as the timely and effective handling of abnormal conditions. Efficiency refers to maximizing the utilization of system resources to quickly and efficiently supply power to the PDs. Accuracy refers to identifying the communication ports that need to be powered or excluded at each stage of the power management of the system as early as possible. Configurability refers to providing multiple optional combinations in the power management strategy to meet various user needs. Among these, safety and efficiency are two opposing objectives; safety emphasizes the conservative use of system power, while efficiency seeks to maximize the use of system power.

There are two common types of the PoE systems with multiple communication ports. One type of the PoE systems includes a Microcontroller Unit (MCU) and multiple Power Sourcing Equipment (PSE) chips. The host of the system communicates with the MCU through a Universal Asynchronous Receiver/Transmitter (UART) or Inter-Integrated Circuit (I²C) interface to exchange messages, thereby completing various configurations including power management procedures and status information acquisition. The MCU accesses each of the PSE chips through the I2C interface. The other type of the PoE systems includes only a single PSE chip and a memory (such as an Electrically-Erasable Programmable Read-Only Memory, EEPROM), and the power management procedure is executed solely by the single PSE chip.

However, as known to the inventor, in systems that include an MCU and multiple PSE chips, the MCU needs to periodically poll the PSE chips in the system. The MCU has to collect all information before making decisions, which often results in control cycles of tens or hundreds of milliseconds (ms), a relatively long time. The number of ports in the system is also limited by the MCU software and cannot be expanded. Additionally, the system is costly due to the inclusion of the MCU. As for systems that include only a single PSE chip and memory, the number of ports in the system is limited to the number of ports on the single PSE chip and cannot be expanded.

### SUMMARY

In some embodiments, a power management method is adapted to be applied to a multi-chip system. The multi-chip system comprises a plurality of chips. Each of the chips has a priority. Each of the chips comprises a processing unit, a storage unit, and a plurality of communication ports. The storage unit is configured to store a mode value and a used power value. The mode value is either a static mode value or a dynamic mode value. The power management method comprises: executing an initialization procedure by using the processing unit to obtain a remaining available power value, wherein the initialization procedure comprises: reading the mode value by using the processing unit to determine whether the mode value is the dynamic mode value or the static mode value; reading the used power value of the storage unit of the chip having a previous priority by using the processing unit; and subtracting the used power value of the storage unit of the chip having the previous priority from a total power value by using the processing unit to obtain the remaining available power value; sequentially executing a power supply procedure for each of the communication ports by using the processing unit, wherein the power supply procedure comprises: detecting and classifying the communication port by using the processing unit to obtain a required power value of the communication port; comparing the remaining available power value with the required power value by using the processing unit; and in response to that the remaining available power value is greater than or equal to the required power value, supplying power to the communication port and subtracting the required power value from the remaining available power value by using the processing unit to obtain an updated remaining available power value; calculating the power consumed by each of the communication ports that are powered on by using the processing unit, wherein, if the mode value is the static mode value, the power consumed by each of the communication ports is the required power value of each of the communication ports; summing the power consumed by all the communication ports that are powered on by using the processing unit to obtain a local used power value; subtracting the used power value of the storage unit of the chip having the previous priority and the local used power value from the total power value by using the processing unit to obtain a second remaining available power value; and in response to that the second remaining available power value is greater than or equal to 0, adding the local used power value to the used power value of the storage unit of the chip having the previous priority by using the processing unit to obtain the used power value and storing the used power value in the storage unit.

In some embodiments, when the processing unit calculates the power consumed by each of the communication ports that are powered on, if the mode value is the dynamic mode value, the power consumed by each of the communication ports is a real-time voltage value of each of the communication ports multiplied by a real-time current value of each of the communication ports.

In some embodiments, the power management method further comprises: in response to that the second remaining available power value is less than 0, stopping supplying power to one of the communication ports that are powered on and recalculating the local used power value and the second remaining available power value by using the processing unit.

In some embodiments, the power supply procedure further comprises: after the processing unit supplies power to the communication port, waiting for a stabilization time by using the processing unit to confirm that a power-on state of the communication port is stable.

In some embodiments, the initialization procedure further comprises: checking whether the chip having the previous priority is malfunctioned based on the priority by using the processing unit; and in response to that the chip having the previous priority is not malfunctioned, reading the used power value of the storage unit of the chip having the previous priority by using the processing unit.

In some embodiments, for each of the chips, the priority of the chip is determined by an address of the chip.

In some embodiments, each of the communication ports has a second priority, and in response to that the second remaining available power value is less than 0, the processing unit stops supplying power to one of the communication ports that are powered on based on the second priority of each of the communication ports.

In some embodiments, the processing unit sequentially executes the power supply procedure for each of the communication ports based on the second priority of each of the communication ports.

In some embodiments, the initialization procedure further comprises: storing the mode value in the storage unit based on firmware configuration information by using the processing unit.

In some embodiments, the multi-chip system further comprises a processor. The initialization procedure further comprises: storing the mode value in the storage unit based on firmware configuration information by using the processor.

In some embodiments, a multi-chip system comprises a plurality of chips. Each of the chips has a priority. Each of the chips comprises a storage unit, a plurality of communication ports, and a processing unit. The storage unit is configured to store a mode value and a used power value. The mode value is either a static mode value or a dynamic mode value. The processing unit is configured to execute a power management method. The power management method comprises: executing an initialization procedure to obtain a remaining available power value, wherein the initialization procedure comprises: reading the mode value to determine whether the mode value is the dynamic mode value or the static mode value; reading the used power value of the storage unit of the chip having a previous priority; and subtracting the used power value of the storage unit of the chip having the previous priority from a total power value to obtain the remaining available power value; sequentially executing a power supply procedure for each of the communication ports, wherein the power supply procedure comprises: detecting and classifying the communication port to obtain a required power value of the communication port; comparing the remaining available power value with the required power value; and in response to that the remaining available power value is greater than or equal to the required power value, supplying power to the communication port and subtracting the required power value from the remaining available power value to obtain an updated remaining available power value; calculating the power consumed by each of the communication ports that are powered on, wherein, if the mode value is the static mode value, the power consumed by each of the communication ports is the required power value of each of the communication ports; summing the power consumed by all the communication ports that are powered on to obtain a local used power value; subtracting the used power value of the storage unit of the chip having the previous priority and the local used power value from the total power value to obtain a second remaining available power value; and in response to that the second remaining available power value is greater than or equal to 0, adding the local used power value to the used power value of the storage unit of the chip having the previous priority to obtain the used power value and storing the used power value in the storage unit.

The following will describe the detailed features and advantages of the instant disclosure in detail in the detailed description. The content of the description is sufficient for any person skilled in the art to comprehend the technical context of the instant disclosure and to implement it accordingly. According to the content, claims and drawings disclosed in the instant specification, any person skilled in the art can readily understand the goals and advantages of the instant disclosure.

### BRIEF DESCRIPTION OF THE DRAWINGS

The disclosure will become more fully understood from the detailed description given herein below for illustration only, and thus not limitative of the disclosure, wherein:

FIG. 1 illustrates a block schematic diagram of a multi-chip system according to an embodiment.

FIG. 2A and FIG. 2B illustrate a flowchart of a power management method according to an embodiment.

FIG. 3 illustrates a flowchart of an initialization procedure according to an embodiment.

FIG. 4 illustrates a flowchart of a power supply procedure according to an embodiment.

FIG. 5 illustrates a flowchart of an initialization procedure according to another embodiment.

FIG. 6 illustrates a flowchart of an initialization procedure according to yet another embodiment.

FIG. 7 illustrates a block schematic diagram of a multi-chip system according to another embodiment.

FIG. 8 illustrates a flowchart of an initialization procedure according to a further embodiment.

### DETAILED DESCRIPTION

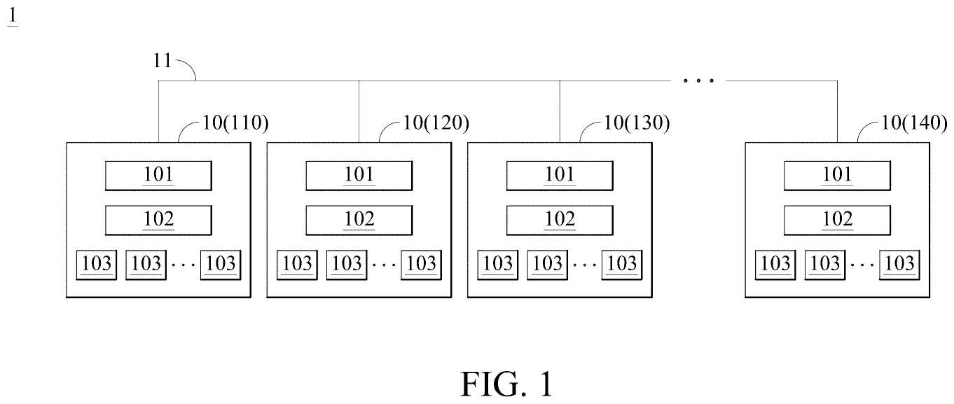

FIG. 1 illustrates a block schematic diagram of a multi-chip system according to an embodiment. Please refer to FIG. 1. The multi-chip system 1 comprises a plurality of chips 10. Each of the chips 10 comprises a storage unit 102, a plurality of communication ports 103, and a processing unit 101. The storage unit 102 is configured to store a mode value and a used power value. The mode value is either a static mode value or a dynamic mode value. The processing unit 101 is configured to execute a power management method. In some embodiments, the chip 10 may be but not limited to a PSE chip.

In some embodiments, each of the chips 10 is connected to each other through a bus 11. In some embodiments, the bus 11 may be but not limited to an Inter-Integrated Circuit (I²C).

In some embodiments, each of the chips 10 has a priority. In some embodiments, for each of the chips 10, the priority of the chip 10 is determined by an address of the chip 10. In some embodiments, the priority of each of the chips 10 decreases from the chip 10 with the lowest address to the chip 10 with the highest address; that is, in some embodiments, the chip 10 with the lowest address has the highest priority. Taking the multi-chip system 1 in FIG. 1 as an example, for convenience of illustration, the chips 10 in FIG. 1 are referred to as chip 110, chip 120, chip 130, and chip 140, respectively. Suppose that the address of chip 110 is A, the address of chip 120 is A+1, the address of chip 130 is A+2, and the address of chip 140 is A+n. Because the chip 110 has the lowest address, the chip 110 has the highest priority. Because the chip 120 has the second lowest address, the chip 120 has the second highest priority. That is, the chip 120 is the chip 10 having the next priority of the chip 110. In other words, the chip 110 is the chip 10 having the previous priority of the chip 120. Because the chip 130 has the third lowest address, the chip 130 has the third highest priority. Because the chip 140 has the highest address, the chip 140 has the lowest priority.

In some embodiments, the multi-chip system 1 supplies power to each of the chips 10 based on the priority of each of the chips 10, where the higher the priority of the chip 10, the sooner the chip 10 is powered on. Taking the multi-chip system 1 in FIG. 1 as an example, the chip 110 is powered on first, followed by the chip 120, and then the chip 130; as to the chip 140, the chip 140 will be powered on after all chips 10 having a higher priority as compared with the priority of the chip 140 have been powered on.

In some embodiments, the used power value stored in the storage unit 102 is the sum of the used power value of the chip 10 having the previous priority of the chip 10 where the storage unit 102 is located and a local used power value of the chip 10 where the storage unit 102 is located. That is, in some embodiments, the used power value stored in the storage unit 102 is the sum of the local used power values of all chips 10 having a higher priority than the chip 10 where the storage unit 102 is located plus the local used power value of the chip 10 where the storage unit 102 is located. Taking the multi-chip system 1 in FIG. 1 as an example, because the chip 110 has the highest priority, the used power value stored in the storage unit 102 of the chip 110 is only the local used power value of the chip 110 per se. The used power value stored in the storage unit 102 of the chip 120 is the sum of the used power value of the chip 110 and the local used power value of the chip 120. That is, in some embodiments, the used power value stored in the storage unit 102 of the chip 120 is the sum of the local used power values of the chip 110 and the chip 120. Likewise, the used power value stored in the storage unit 102 of the chip 130 is the sum of the used power value stored in the storage unit 102 of the chip 120 and the local used power value of the chip 130. That is, in some embodiments, the used power value stored in the storage unit 102 of the chip 130 is the sum of the local used power values of the chip 110, the chip 120, and the chip 130. The used power value stored in the storage unit 102 of the chip 140 is the sum of the local used power values of all chips 10 having a higher priority as compared with the priority of the chip 140 plus the local used power value of the chip 140.

In some embodiments, all of the chips 10 included in the multi-chip system 1 share a total power. In some embodiments, the total power shared by all of the chips 10 included in the multi-chip system 1 is the total power of the multi-chip system 1, but the instant disclosure is not limited thereto. In some embodiments, the total power shared by all of the chips 10 included in the multi-chip system 1 is set by a user rather than being the total power of the multi-chip system 1. In some embodiments, a total power value shared by all of the chips 10 included in the multi-chip system 1 is stored in the storage unit 102 of each of the chips 10, but the instant disclosure is not limited thereto.

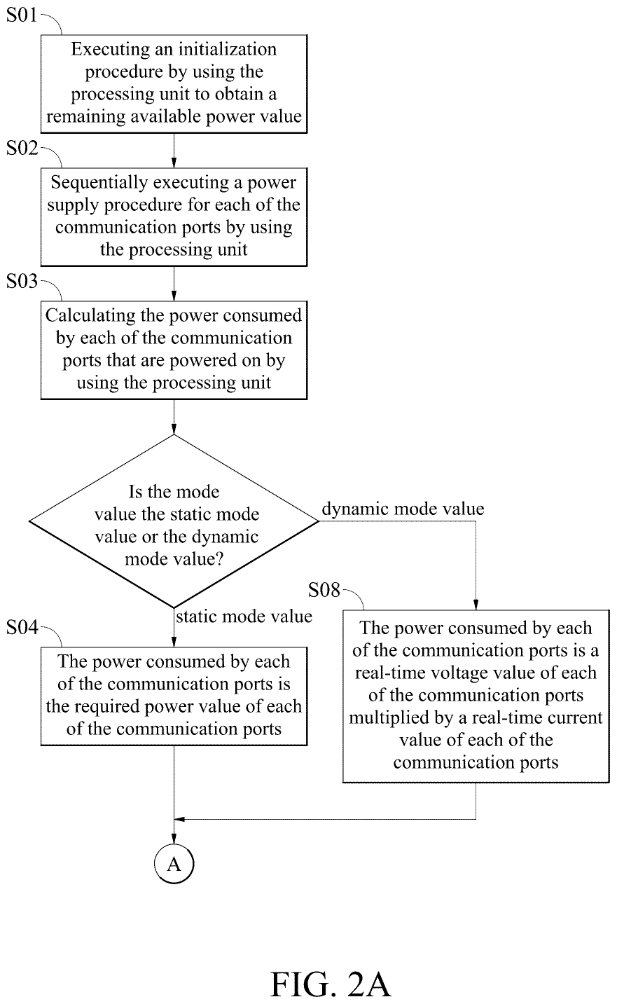

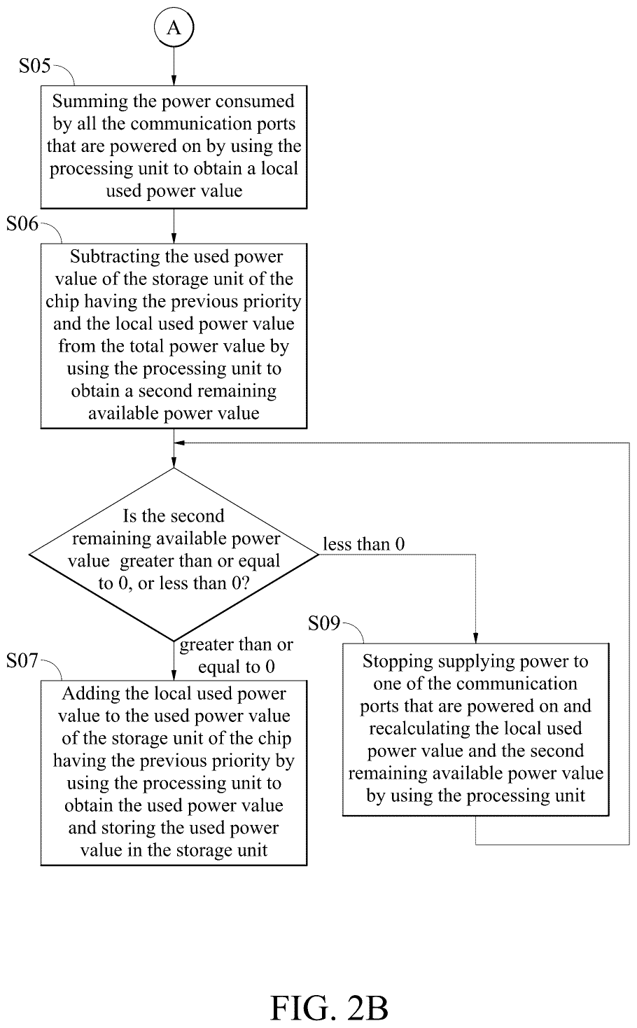

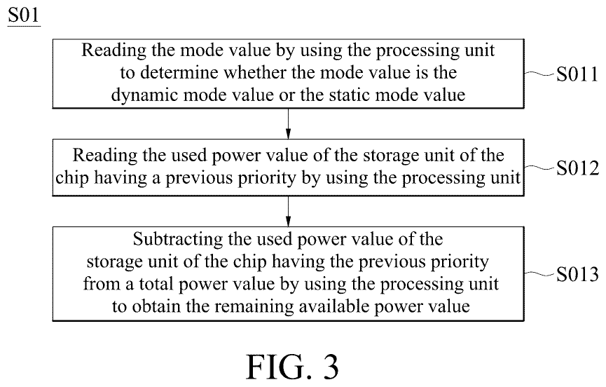

FIG. 2A and FIG. 2B illustrate a flowchart of a power management method according to an embodiment. Please refer to FIG. 2A and FIG. 2B. First, the processing unit 101 executes an initialization procedure to obtain a remaining available power value (Step S01). FIG. 3 illustrates a flowchart of the initialization procedure according to an embodiment. Please refer to FIG. 3. First, the processing unit 101 reads the mode value to determine whether the mode value is the dynamic mode value or the static mode value (Step S011). Next, the processing unit 101 reads the used power value of the storage unit 102 of the chip 10 having the previous priority (Step S012). Last, the processing unit 101 subtracts the used power value of the storage unit 102 of the chip 10 having the previous priority from the total power value to obtain the remaining available power value (Step S013). In Step S013, all of the chips 10 share the total power and the multi-chip system 1 supplies power to each of the chips 10 based on the priority of each of the chips 10, and the used power value stored in the storage unit 102 is the sum of the local used power values of all of the chips 10 before the chip 10 where the storage unit 102 is located plus the local used power value of the chip 10 where the storage unit 102 is located. Therefore, the processing unit 101 only needs to subtract the used power value of the storage unit 102 of the chip 10 having the previous priority from the total power value to obtain the remaining available power value, which represents how much power can be utilized by the chip 10 where the processing unit 101 is located.

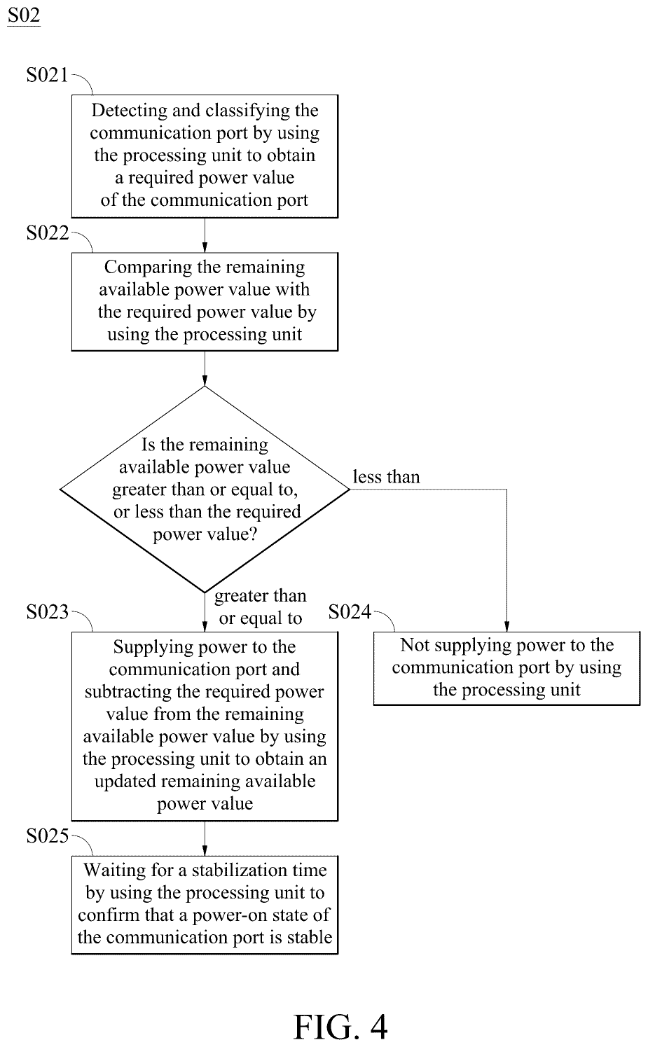

Next, the processing unit 101 sequentially executes a power supply procedure for each of the communication ports 103; that is, in this embodiment, the processing unit 101 executes the power supply procedure for only one communication port 103 within a cycle (Step S02). FIG. 4 illustrates a flowchart of a power supply procedure according to an embodiment. Please refer to FIG. 4. First, the processing unit 101 detects and classifies the communication port 103 to obtain a required power value of the communication port 103 (Step S021). Next, the processing unit 101 compares the remaining available power value with the required power value (Step S022). In response to that the remaining available power value is greater than or equal to the required power value, the processing unit 101 supplies power to the communication port 103 and subtracts the required power value from the remaining available power value to obtain an updated remaining available power value (Step S023). When the remaining available power value is less than the required power value, the processing unit 101 does not supply power to the communication port 103 (Step S024).

In some embodiments, after the processing unit 101 supplies power to the communication port 103, the processing unit 101 further waits for a stabilization time to confirm that a power-on state of the communication port 103 is stable (Step S025). In some embodiments, the stabilization time may be but not limited to 250 milliseconds (ms).

In some embodiments, each of the communication ports 103 has a second priority. In some embodiments, the processing unit 101 sequentially executes the power supply procedure for each of the communication ports 103 based on the second priority of each of the communication ports 103, wherein the higher the second priority of the communication port 103 is, the sooner the processing unit 101 executes the power supply procedure for the communication port 103. In some embodiments, each of the communication ports 103 comprises an identification number, and the second priority of each of the communication ports 103 may be but not limited to determined by the identification number of each of the communication ports 103. In some embodiments, the smaller the identification number, the higher the second priority, but the instant disclosure is not limited thereto.

In some embodiments, in Step S021, the processing unit 101 detects and classifies the communication port 103 based on the IEEE 802.3at and IEEE 802.3bt standards to obtain the required power value of the communication port 103.

Then, the processing unit 101 calculates the power consumed by each of the communication ports 103 that are powered on (Step S03). If the mode value is the static mode value, the power consumed by each of the communication ports 103 is the required power value of each of the communication ports 103 (Step S04). If the mode value is the dynamic mode value, the power consumed by each of the communication ports 103 is a real-time voltage value of each of the communication ports 103 multiplied by a real-time current value of each of the communication ports 103 (Step S08).

In some embodiments, when the processing unit 101 calculates the power consumed by each of the communication ports 103 that are powered on (Step S03), if the mode value is the static mode value or if a power-on time of each of the communication ports 103 is less than the stabilization time, the power consumed by each of the communication ports 103 is the required power value of each of the communication ports 103 (Step S04). While if the mode value is the dynamic mode value and the power-on time of each of the communication ports 103 is greater than or equal to the stabilization time, the power consumed by each of the communication ports 103 is the real-time voltage value of each of the communication ports 103 multiplied by the real-time current value of each of the communication ports 103 (Step S08).

Then, the processing unit 101 sums the power consumed by all the communication ports 103 that are powered on to obtain a local used power value (Step S05). Next, the processing unit 101 subtracts the used power value of the storage unit 102 of the chip 10 having the previous priority and the local used power value from the total power value to obtain a second remaining available power value (Step S06). In response to that the second remaining available power value is greater than or equal to 0, the processing unit 101 adds the local used power value to the used power value of the storage unit 102 of the chip 10 having the previous priority to obtain the used power value and stores the used power value in the storage unit 102 (Step S07). In response to that the second remaining available power value is less than 0, the processing unit 101 stops supplying power to one of the communication ports 103 that are powered on and recalculates the local used power value and the second remaining available power value (Step S09), and then the processing unit 101 determines again whether the second remaining available power value is greater than or equal to 0, or less than 0.

In some embodiments, in Step S09, in response to that the second remaining available power value is less than 0, the processing unit 101 stops supplying power to one of the plurality of communication ports 103 that are powered on based on the second priority of each of the communication ports 103. In some embodiments, the processing unit 101 preferentially stops supplying power to the communication port 103 having the lowest second priority. That is, in some embodiments, the processing unit 101 preferentially stops supplying power to the communication port 103 with the largest identification number.

It is particularly noted that if the mode value is the static mode value, the power consumed by each of the communication ports 103 is the required power value of each of the communication ports 103. The required power value of each of the communication ports 103 is examined during the power supply procedure (Step S02), and the processing unit 101 supplies power to the communication port 103 only when the remaining available power value is greater than or equal to the required power value. Therefore, if the mode value is the static mode value, the sum of the used power value of the storage unit 102 of the chip 10 having the previous priority and the local used power value (i.e., the total power consumed by all powered-on communication ports 103) will not exceed the total power value. That is, if the mode value is the static mode value, the second remaining available power value will not be less than 0. In other words, the situation where the second remaining available power value is less than 0 can only occur if the mode value is the dynamic mode value.

In Step S07, the used power value stored by the processing unit 101 in the storage unit 102 is the used power value read by the processing unit 101 of the chip 10 having the next priority in Step S012.

Because the multi-chip system 1 does not comprise an MCU, the number of the communication ports 103 in each of the chips 10 is not limited by MCU software and can be expanded as needed, and in this embodiment, the number of the communication ports 103 in the multi-chip system 1 would only be limited by the address limit of the bus 11. Moreover, because the multi-chip system 1 does not comprise the MCU, the cost of the multi-chip system 1 is reduced. Furthermore, in the multi-chip system 1, each of the chips 10 determines whether to power on or off the communication ports 103 of the chips 10, rather than relying on MCU instructions, which shortens the control cycle of the multi-chip system 1. In some embodiments, the control cycle of the multi-chip system 1 may be but not limited to 1 ms. Additionally, because each of the chips 10 only needs to obtain power data from the chip 10 having the previous priority, the communication overhead of the multi-chip system 1 is also reduced.

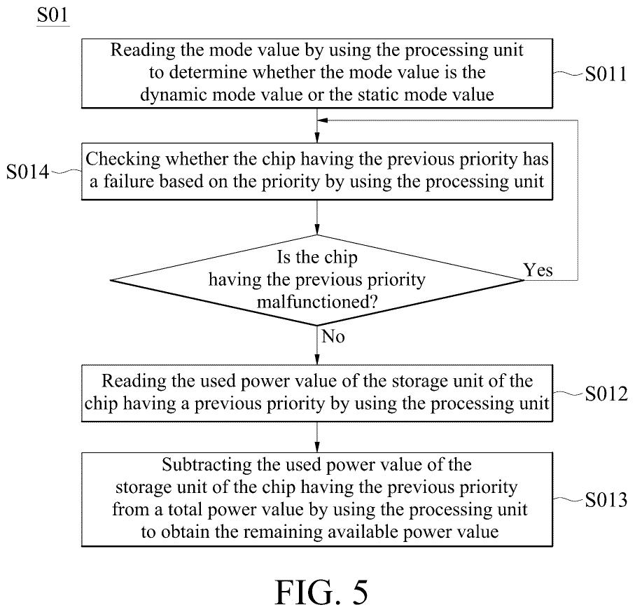

FIG. 5 illustrates a flowchart of an initialization procedure according to another embodiment. Please refer to FIG. 5. In some embodiments, after Step S011, the processing unit 101 further checks whether the chip 10 having the previous priority is malfunctioned based on the priority (Step S014). In response to that the chip 10 having the previous priority is not malfunctioned, the processing unit 101 reads the used power value of the storage unit 102 of the chip 10 having the previous priority (Step S012). In response to that the chip 10 having the previous priority is malfunctioned, the processing unit 101 checks whether the chip 10 having the next previous priority is malfunctioned until a chip 10 being not malfunctioned is found, and then the processing unit 101 continues executing Step S012.

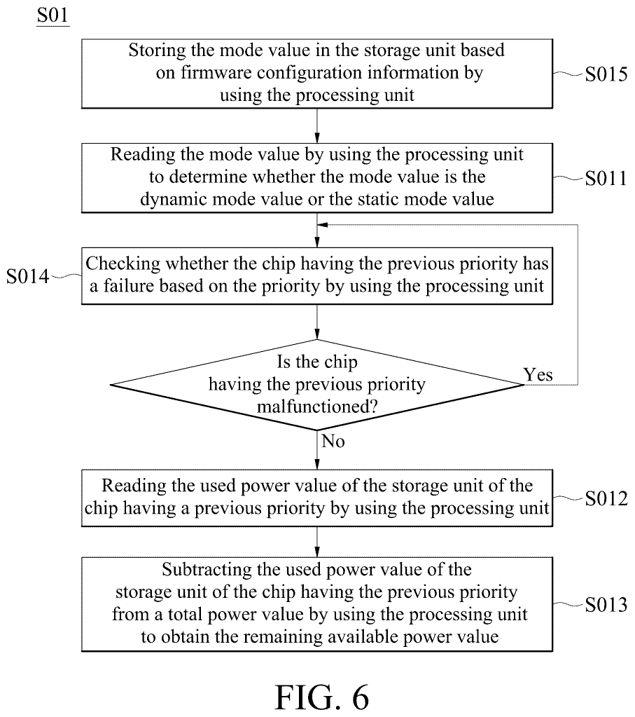

FIG. 6 illustrates a flowchart of an initialization procedure according to yet another embodiment. Please refer to FIG. 6. In some embodiments, before Step S011, the processing unit 101 further stores the mode value in the storage unit 102 based on firmware configuration information (Step S015). In some embodiments, the firmware configuration information is stored in the storage unit 102 of each of the chips 10, but the instant disclosure is not limited thereto.

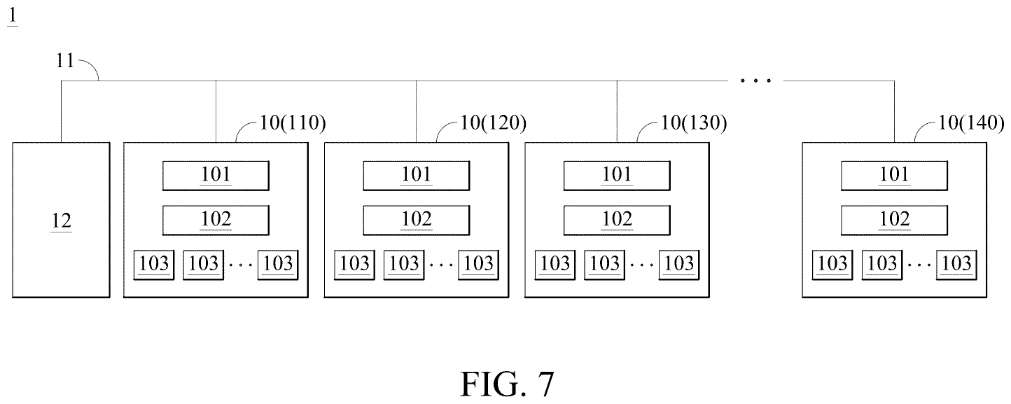

FIG. 7 illustrates a block schematic diagram of a multi-chip system according to another embodiment. Please refer to FIG. 7. In some embodiments, the multi-chip system 1 further comprises a processor 12. The processor 12 is connected to each of the chips 10 through the bus 11. In some embodiments, the processor 12 may serve only as an observer to acquire real-time information of each of the chips 10 through the bus 11, but the instant disclosure is not limited thereto. In some embodiments, the processor 12 may also be configured to switch from a peer-to-peer mode to a master-slave mode to manage each of the chips 10.

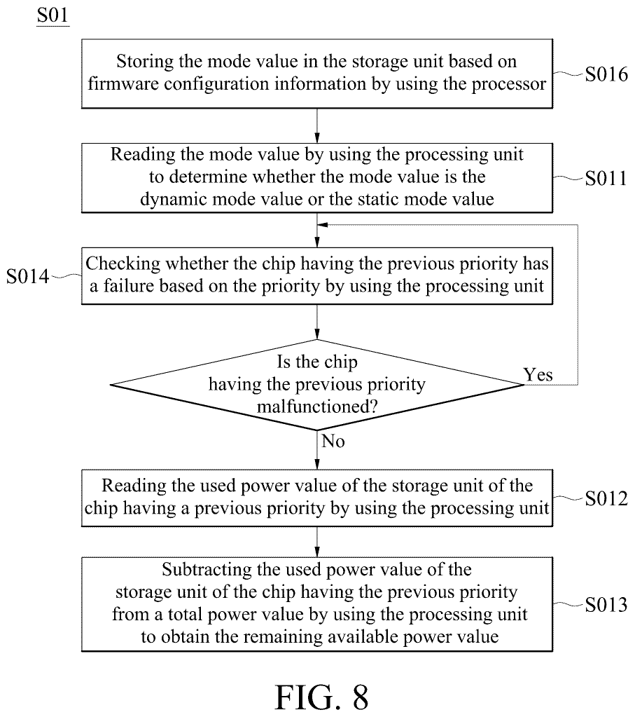

FIG. 8 illustrates a flowchart of an initialization procedure according to a further embodiment. Please refer to FIG. 8. In some embodiments, before Step S011, the processor 12 further stores the mode value in the storage unit 102 based on the firmware configuration information (Step S016). In some embodiments, the processor 12 further comprises a second storage unit. In some embodiments, the firmware configuration information is stored in the second storage unit of the processor 12, but the instant disclosure is not limited thereto.

To sum up, in some embodiments, because the multi-chip system 1 does not comprise an MCU, the number of communication ports 103 in each of the chips 10 is not limited by MCU software and can be expanded as needed. Moreover, because the multi-chip system 1 does not comprise the MCU, the cost of the multi-chip system 1 is reduced. Furthermore, in the multi-chip system 1, each of the chips 10 determines whether to power on or off the communication ports 103 of the chips 10, rather than relying on MCU instructions, which shortens the control cycle of the multi-chip system 1. Additionally, because each of the chips 10 only needs to obtain power data from the chip 10 having the previous priority, the communication overhead of the multi-chip system 1 is also reduced.

Although the instant disclosure has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A power management method, adapted to be applied to a multi-chip system, wherein the multi-chip system comprises a plurality of chips, each of the chips has a priority, each of the chips comprises a processing unit, a storage unit, and a plurality of communication ports, the storage unit is configured to store a mode value and a used power value, the mode value is either a static mode value or a dynamic mode value, and the power management method comprises:
executing an initialization procedure by using the processing unit to obtain a remaining available power value, wherein the initialization procedure comprises:
reading the mode value by using the processing unit to determine whether the mode value is the dynamic mode value or the static mode value;
reading the used power value of the storage unit of the chip having a previous priority by using the processing unit; and
subtracting the used power value of the storage unit of the chip having the previous priority from a total power value by using the processing unit to obtain the remaining available power value;
sequentially executing a power supply procedure for each of the communication ports by using the processing unit, wherein the power supply procedure comprises:
detecting and classifying the communication port by using the processing unit to obtain a required power value of the communication port;
comparing the remaining available power value with the required power value by using the processing unit; and
in response to that the remaining available power value is greater than or equal to the required power value, supplying power to the communication port and subtracting the required power value from the remaining available power value by using the processing unit to obtain an updated remaining available power value;
calculating the power consumed by each of the communication ports that are powered on by using the processing unit, wherein, if the mode value is the static mode value, the power consumed by each of the communication ports is the required power value of each of the communication ports;
summing the power consumed by all the communication ports that are powered on by using the processing unit to obtain a local used power value;
subtracting the used power value of the storage unit of the chip having the previous priority and the local used power value from the total power value by using the processing unit to obtain a second remaining available power value; and
in response to that the second remaining available power value is greater than or equal to 0, adding the local used power value to the used power value of the storage unit of the chip having the previous priority by using the processing unit to obtain the used power value and storing the used power value in the storage unit.

2. The power management method according to claim 1, wherein when the processing unit calculates the power consumed by each of the communication ports that are powered on, if the mode value is the dynamic mode value, the power consumed by each of the communication ports is a real-time voltage value of each of the communication ports multiplied by a real-time current value of each of the communication ports.

3. The power management method according to claim 2, further comprising:
in response to that the second remaining available power value is less than 0, stopping supplying power to one of the communication ports that are powered on and recalculating the local used power value and the second remaining available power value by using the processing unit.

4. The power management method according to claim 3, wherein the power supply procedure further comprises:
after the processing unit supplies power to the communication port, waiting for a stabilization time by using the processing unit to confirm that a power-on state of the communication port is stable.

5. The power management method according to claim 4, wherein the initialization procedure further comprises:
checking whether the chip having the previous priority is malfunctioned based on the priority by using the processing unit; and
in response to that the chip having the previous priority is malfunctioned, reading the used power value of the storage unit of the chip having the previous priority by using the processing unit.

6. The power management method according to claim 5, wherein for each of the chips, the priority of the chip is determined by an address of the chip.

7. The power management method according to claim 6, wherein each of the communication ports has a second priority, and in response to that the second remaining available power value is less than 0, the processing unit stops supplying power to one of the communication ports that are powered on based on the second priority of each of the communication ports.

8. The power management method according to claim 7, wherein the processing unit sequentially executes the power supply procedure for each of the communication ports based on the second priority of each of the communication ports.

9. The power management method according to claim 8, wherein the initialization procedure further comprises:
storing the mode value in the storage unit based on firmware configuration information by using the processing unit.

10. The power management method according to claim 8, wherein the multi-chip system further comprises a processor, and the initialization procedure further comprises:
storing the mode value in the storage unit based on firmware configuration information by using the processor.

11. A multi-chip system, comprising:
a plurality of chips each having a priority, wherein each of the chips comprises:
a storage unit, configured to store a mode value and a used power value, wherein the mode value is either a static mode value or a dynamic mode value;
a plurality of communication ports; and
a processing unit, configured to execute a power management method, wherein the power management method comprises:
executing an initialization procedure to obtain a remaining available power value, wherein the initialization procedure comprises:
reading the mode value to determine whether the mode value is the dynamic mode value or the static mode value;
reading the used power value of the storage unit of the chip having a previous priority; and
subtracting the used power value of the storage unit of the chip having the previous priority from a total power value to obtain the remaining available power value;
sequentially executing a power supply procedure for each of the communication ports, wherein the power supply procedure comprises:
detecting and classifying the communication port to obtain a required power value of the communication port;
comparing the remaining available power value and the required power value; and
in response to that the remaining available power value is greater than or equal to the required power value, supplying power to the communication port and subtracting the required power value from the remaining available power value to obtain an updated remaining available power value;
calculating the power consumed by each of the communication ports that are powered on, wherein, if the mode value is the static mode value, the power consumed by each of the communication ports is the required power value of each of the communication ports;
summing the power consumed by all the communication ports that are powered on to obtain a local used power value;
subtracting the used power value of the storage unit of the chip having the previous priority and the local used power value from the total power value to obtain a second remaining available power value; and
in response to that the second remaining available power value is greater than or equal to 0, adding the local used power value to the used power value of the storage unit of the chip having the previous priority to obtain the used power value and storing the used power value in the storage unit.

12. The multi-chip system according to claim 11, wherein when the processing unit calculates the power consumed by each of the communication ports that are powered on, if the mode value is the dynamic mode value, the power consumed by each of the communication ports is a real-time voltage value of each of the communication ports multiplied by a real-time current value of each of the communication ports.

13. The multi-chip system according to claim 12, wherein the power management method further comprises:
in response to that the second remaining available power value is less than 0, stopping supplying power to one of the communication ports that are powered on, and recalculating the local used power value and the second remaining available power value.

14. The multi-chip system according to claim 13, wherein the power supply procedure further comprises:
after the processing unit supplies power to the communication port, waiting for a stabilization time to confirm that a power-on state of the communication port is stable.

15. The multi-chip system according to claim 14, wherein the initialization procedure further comprises:
checking whether the chip having the previous priority is malfunctioned based on the priority; and
in response to that the chip having the previous priority is not malfunctioned, reading the used power value of the storage unit of the chip having the previous priority.

16. The multi-chip system according to claim 15, wherein for each of the chips, the priority of the chip is determined by an address of the chip.

17. The multi-chip system according to claim 16, wherein each of the communication ports has a second priority, and in response to that the second remaining available power value is less than 0, the processing unit stops supplying power to one of the communication ports that are powered on based on the second priority of each of the communication ports.

18. The multi-chip system according to claim 17, wherein the processing unit sequentially executes the power supply procedure for each of the communication ports based on the second priority of each of the communication ports.

19. The multi-chip system according to claim 18, wherein the initialization procedure further comprises:
storing the mode value in the storage unit based on firmware configuration information.

20. The multi-chip system according to claim 18, further comprising a processor, wherein the initialization procedure further comprises:
storing the mode value in the storage unit based on firmware configuration information by using the processor.
